(19) United States
(12) Patent Application Publication
(10) Pub. No.: US 2008/0117288 A1
(43) Pub. Date: May 22, 2008

(54) Distributed Video Sensor Panoramic Imaging System

(75) Inventor: Michael C. Park, Portland, OR (US)

Correspondence Address: FENWICK & WEST LLP, SILICON VALLEY CENTER, 801 CALIFORNIA STREET, MOUNTAIN VIEW, CA, 94041, US

(73) Assignee: IMOVE, INC., Portland, OR (US)

(21) Appl. No.: 11/928,016

(22) Filed: Oct. 30, 2007

Related U.S. Application Data
(60) Provisional application No. 60/866,179, filed on Nov. 16, 2006.

(51) Int. Cl. H04N 7/00

(52) U.S. Cl. 348/36

(57) ABSTRACT

A panoramic imaging system includes a plurality of separated video cameras that may be distributed around an object. A series of images captured by at least one of the separated video cameras is stored in a first file format. The panoramic system further includes a viewer module that may render the series of images using the first file format. Moreover, the panoramic system includes a calibration module capable of modifying information associated with at least one of the series of images, where the modification results in the series of images being stored in a second file format. The viewer module may also be capable of rendering the series of images using the second file format.

### CROSS REFERENCE TO RELATED APPLICATIONS

This application claims priority under 35 U.S.C. § 119(e) to co-pending U.S. Provisional Patent Application No. 60/866,179 entitled “Distributed Video Sensor Panoramic Imaging System,” filed on Nov. 16, 2006, the subject matter of which is incorporated by reference herein in its entirety.

### BACKGROUND

In general, “panoramic imaging” refers to the ability for showing a visual scene with a relatively high degree field of view. For example, panoramic imaging may involve capturing images showing a 360° field of view around a particular object.

While a field of view of a single camera can be increased to some extent, generally multiple cameras are needed to capture a true panoramic scene. A typical way to perform panoramic imaging involves the use of a “fixed head” immersive video sensor. As shown in FIG. 1, this type of video sensor 10 is formed of multiple video cameras 12, 14, 16, 18, 20, 22. The video cameras 12, 14, 16, 18, 20, 22 are positioned close to each other around a fixed head 24 (the fixed head 24 preferably being as small as possible to allow the video cameras 12, 14, 16, 18, 20, 22 to be positioned closer to each other) such that they collectively have a 360° field of view around the fixed head 24. Typically, the video cameras 12, 14, 16, 18, 20, 22 are positioned close to each other and set to each have a 60-62° field of view (thus, allowing for slight overlap among the edges of images captured by the video cameras 12, 14, 16, 18, 20). Thus, in general, a fixed head immersive video sensor, such as one of the type shown in FIG. 1, can be used to capture images in all directions from a single, fixed point in space.

Deploying a fixed head immersive video sensor involves positioning the sensor on the exterior of an object from which a panoramic image is desired. For example, should one wish to capture a panoramic image around a vehicle (for, for example, safety or surveillance purposes), the fixed head immersive video sensor could be attached to the vehicle roof, at some height therefrom, in order to minimize or remove any visual obstructions that might otherwise be caused by the vehicle itself. However, such exterior deployment of the fixed head immersive video sensor may subject the sensor to, for example, adverse weather conditions (e.g., humidity, rain, wind), travel conditions (e.g., wind at high speeds, height clearance, drag), and structural issues (e.g., if the vehicle is very wide and/or long, the sensor will have to be disposed at a greater height to avoid visual obstructions caused by the vehicle, thereby requiring increased attention and potential expense to the mechanism or structure supporting the sensor above the vehicle). Moreover, for example, in a military application in which a fixed head immersive video sensor is used for enemy surveillance, the exteriorly positioned sensor represents a fairly unprotected point of attack by which the enemy can bring down the entire surveillance system with a single shot.

Additionally, a fixed head immersive video sensor could be positioned inside the object, but this often introduces obstructions into the field of view. For example, if a fixed head immersive video sensor is positioned in the interior of a vehicle, the roof, doors, dashboard, seats, occupants, and other opaque objects within the vehicle would obstruct one or more portions of the cumulative field of view of the fixed head immersive video sensor.

### SUMMARY

According to at least one aspect of one or more embodiments of the present invention, a panoramic imaging system includes a plurality of separated video cameras that may be distributed around an object. A series of images captured by at least one of the separated video cameras is stored in a first file format. The system further includes a viewer module that may render the series of images using the first file format. Moreover, the system includes a calibration module capable of modifying information associated with at least one of the series of images, where the modification results in the series of images being stored in a second file format. The viewer module may also be capable of rendering the series of images using the second file format.

According to another aspect of one or more embodiments of the present invention, a panoramic imaging method includes: capturing images with separated video cameras distributed around an object; storing at least one of the captured images in a first file format, where the at least one captured image is renderable according to a first set of information; and aligning the at least one captured image, where the aligning results in generation of a second set of information capable of being stored with the at least one captured image in a second file format, and where the at least one captured image is renderable according to the second of information.

The features and advantages described herein are not all inclusive, and, in particular, many additional features and advantages will be apparent to those skilled in the art in view of the following description. Moreover, it should be noted that the language used herein has been principally selected for readability and instructional purposes and may not have been selected to circumscribe the present invention.

### BRIEF DESCRIPTION OF DRAWINGS

FIG. 1 shows a prior art panoramic imaging system.

FIG. 2 shows a panoramic imaging system in accordance with an embodiment of the present invention.

FIG. 3 shows a video camera arrangement for a panoramic imaging system in accordance with an embodiment of the present invention.

FIG. 4 shows a video camera arrangement for a panoramic imaging system in accordance with an embodiment of the present invention.

FIG. 5 shows a video camera arrangement for a panoramic imaging system in accordance with an embodiment of the present invention.

FIG. 6 shows an alignment technique for a panoramic imaging system in accordance with an embodiment of the present invention.

FIG. 7 shows a screenshot associated with use of a capture module for a panoramic imaging system in accordance with an embodiment of the present invention.

FIG. 8 shows an alignment technique for a panoramic imaging system in accordance with an embodiment of the present invention.

FIG. 9 shows a file format for use in a panoramic imaging system in accordance with an embodiment of the present invention.

FIG. 10 shows a screenshot associated with use of a viewer module for a panoramic imaging system in accordance with an embodiment of the present invention.

FIG. 11 shows a screenshot associated with use of a viewer module for a panoramic imaging system in accordance with an embodiment of the present invention.

FIGS. 12-17 show screenshots associated with use of a calibration module for a panoramic imaging system in accordance with an embodiment of the present invention.

FIG. 18 shows a file format for use in a panoramic imaging system in accordance with an embodiment of the present invention.

Each of the figures referenced above depict an embodiment of the present invention for purposes of illustration only. Those skilled in the art will readily recognize from the following description that one or more other embodiments of the structures, methods, and systems illustrated herein may be used without departing from the principles of the present invention.

### DETAILED DESCRIPTION

In the following description of embodiments of the present invention, numerous specific details are set forth in order to provide a more thorough understanding of the present invention. The embodiments of the present invention may be practiced without one or more of these specific details. In other instances, well-known features have not been described in detail to avoid unnecessarily complicating the description.

In general, embodiments of the present invention relate to a panoramic imaging system that uses separated video cameras distributed around an object. More particularly, in one or more embodiments, separated video cameras may be placed around an interior of an object (e.g., vehicle, a building structure) and adjusted such that each video camera has an unobstructed view of a region exterior to the object. Images captured by the separated video cameras may be rendered in real-time and/or may also be modified after capture to yield a desired panoramic scene.

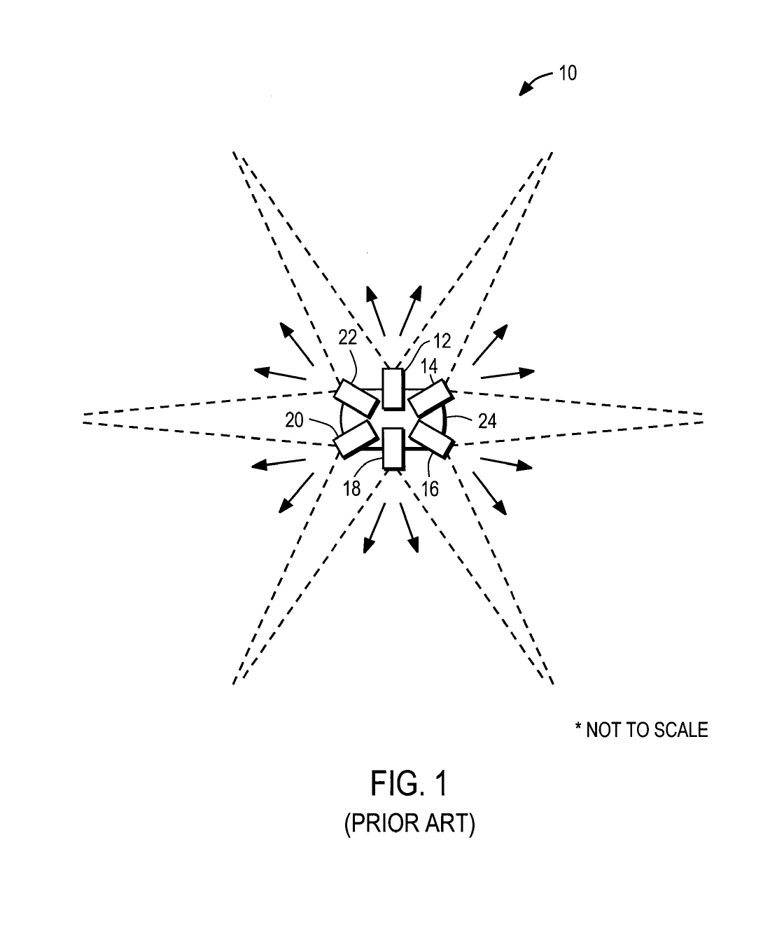

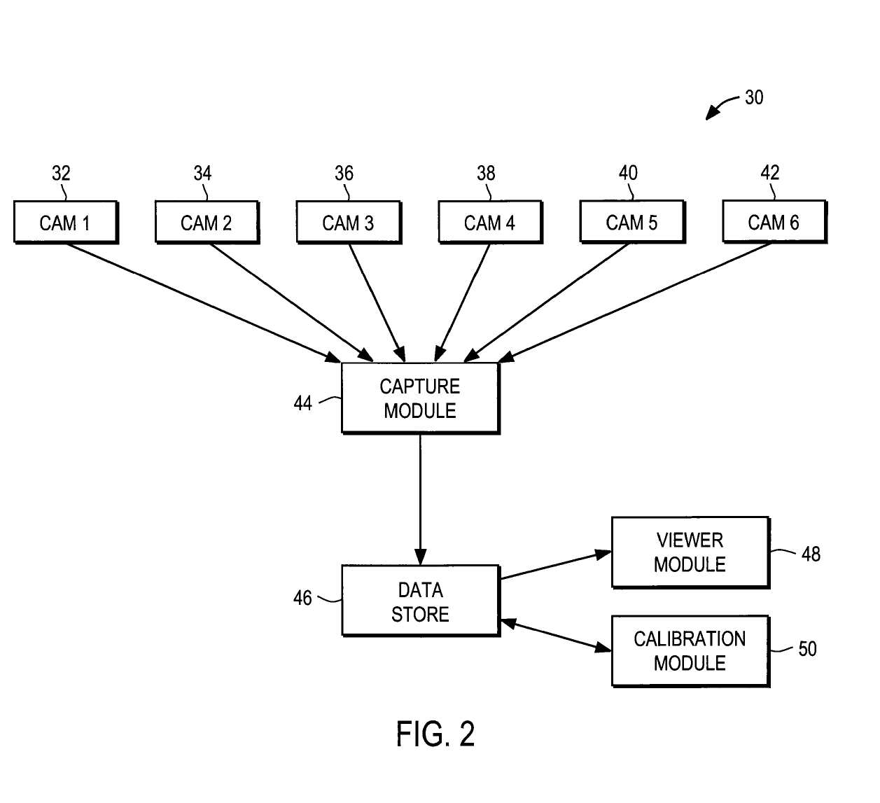

FIG. 2 shows a panoramic imaging system 30 in accordance with an embodiment of the present invention. Video cameras 32, 34, 36, 38, 40, 42 represent separately disposed cameras (i.e., “separately disposed” in that the video cameras 32, 34, 36, 38, 40, 42 are not all positioned on a single fixed head such as that shown in FIG. 1) distributed around some object (not shown). In general, each of the video cameras 32, 34, 36, 38, 40, 42 may be any device that is capable of capturing an image (or video, being a series of images) of the respective field of view of that video camera. There is no limitation on the type of video camera that may be used or whether the video cameras have to be of a similar type.

In one or more embodiments, one or more of the separated video cameras 32, 34, 36, 38, 40, 42 may be an NTSC camera or a PAL camera. Further, in one or more embodiments, one or more of the separated video cameras 32, 34, 36, 38, 40, 42 may be a consumer-version digital (or analog) video camcorder. Moreover, in one or more embodiments, one or more of the separated video cameras 32, 34, 36, 38, 40, 42 may be an internet camera commonly available for use with personal computers (e.g., desktop computers, laptop computers). Additionally, in one or more embodiments, one or more of the separated video cameras 32, 34, 36, 38, 40, 42 may be enabled to wirelessly communicate with one or more of the other components of the panoramic imaging system 30 shown in FIG. 2. Such wireless communication of data may occur using, for example, an 802.11x protocol (e.g., 802.11b protocol, 802.11g protocol), a Bluetooth protocol, one or more radio frequency channels, a wireless access protocol (WAP), and/or a WiMAX protocol.

Further, it is noted that there is no limitation on the number of separated video cameras that may be used in a particular panoramic imaging system. In other words, for example, although FIG. 2 shows the panoramic imaging system 30 as having six separated video cameras 32, 34, 36, 38, 40, 42, another panoramic imaging system may have eight separated video cameras, or, in one or more other embodiments, may have only four separated video cameras.

Also, there is no requirement that a panoramic imaging system in accordance with one or more embodiments be fully immersive. In other words, there is no limitation on the field of view that may be captured by the separated video cameras 32, 34, 36, 38, 40, 42. For example, in one or more embodiments, the desired panorama may span a full 360°, whereas, in one or more other embodiments, the desired panorama may have a field of view of 270°.

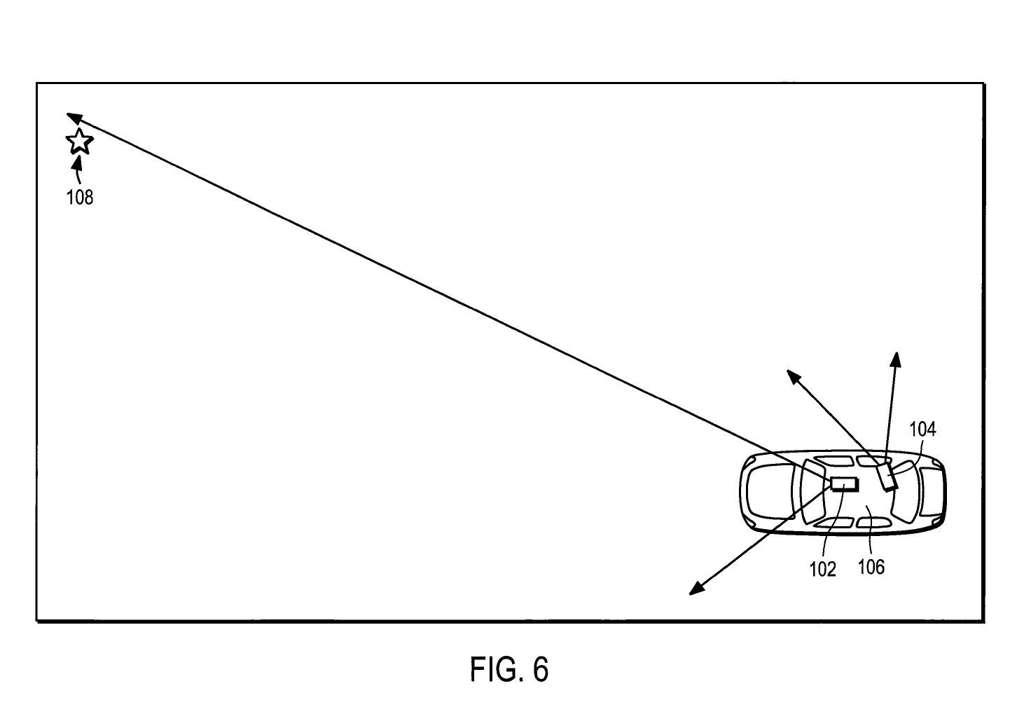

Still referring to FIG. 2, images captured by the separated video cameras 32, 34, 36, 38, 40, 42 are fed to a capture module 44 (use and operation of the capture module 44 further described below with reference to FIGS. 6-8). As used herein, the term “module” refers to any program, logic, and/or functionality that may be implemented in hardware and/or software. In general, the capture module 44 is capable of taking the raw images from the separated video cameras 32, 34, 36, 38, 40, 42 and storing the images in a particular type of file format that is recognizable and processable by other components of the panoramic imaging system 30. In one or more embodiments, each stream of images from each of the separated video cameras 32, 34, 36, 38, 40, 42 may be stored in one file of the particular type of file format. In other words, the capture module 44 may not have to somehow integrate the streams of images received from the separated video cameras 32, 34, 36, 38, 40, 42.

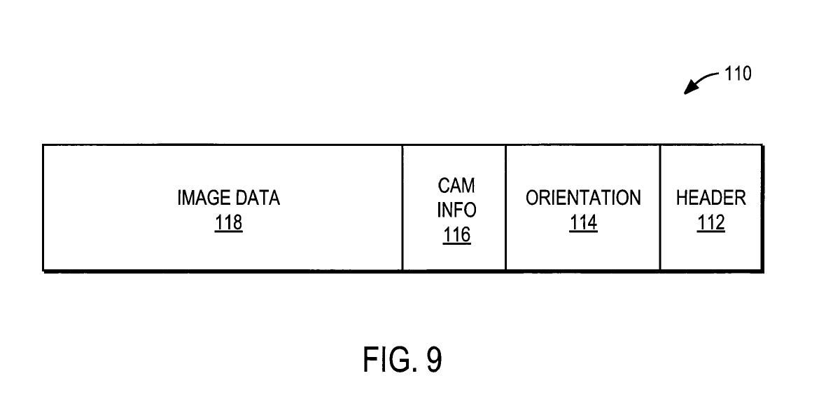

The capture module 44 is operatively connected to a data store 46 to which the capture module 44 provides the streams of images captured from the separated video cameras 32, 34, 36, 38, 40, 42. As described above, in one or more embodiments, the capture module 44, prior to delivery for storage in the data store 46, may convert the raw images captured from the separated video cameras 32, 34, 36, 38, 40, 42 into a particular file format (such a file format further described below with reference to FIG. 9). This conversion may involve adding information to the images captured by the separated video cameras 32, 34, 36, 38, 40, 42. For example, in one or more embodiments, the capture module 44 may add information to a stream of images captured by one of the separated video cameras 32, 34, 36, 38, 40, 42 to associate heading, pitch, and bank information for that stream of images.

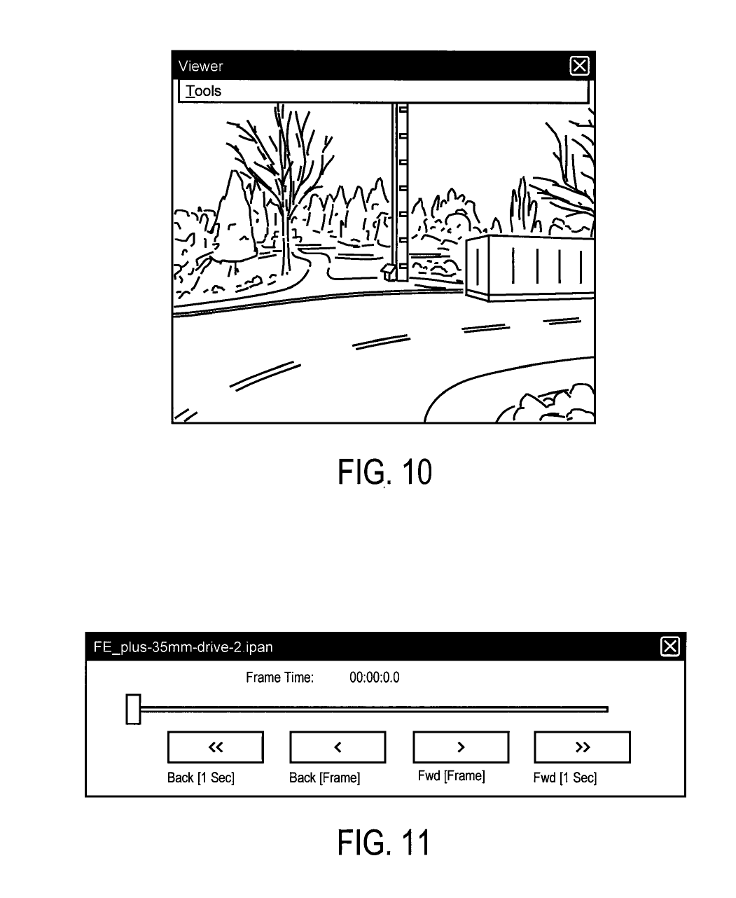

Still referring to FIG. 2, the panoramic imaging system 30 includes a viewer module 48 (use and operation of the viewer module 48 further described below with reference to FIGS. 10 and 11). In general, the viewer module 48 is capable of visually rendering images captured by the separated video cameras 32, 34, 36, 38, 40, 42. As shown in FIG. 2, the viewer module 48 is operatively connected to the data store 46, and as such, in one or more embodiments, the viewer module 48 can take image stream files stored in the data store 48 and render them on some display (e.g., a computer monitor). In other words, in one or more embodiments, the viewer module 48 is capable of rendering the images captured by the separated video cameras 32, 34, 36, 38, 40, 42 in real-time.

The viewer module 48 is further capable of integrating streams of images from the separated video cameras 32, 34, 36, 38, 40, 42 according to some set of information. For example, in one or more embodiments, the viewer module 48 may render a panoramic scene according to a set of default settings. These settings may, for example, make certain assumptions about the positioning of the separated video cameras 32, 34, 36, 38, 40, 42. For example, the default settings may assume evenly spaced, 6.0 mm lens images around a 360° panorama. Further, for example, the default settings may assume that the separated video cameras 32, 34, 36, 38, 40, 42 are ordered around the object in a clockwise manner.

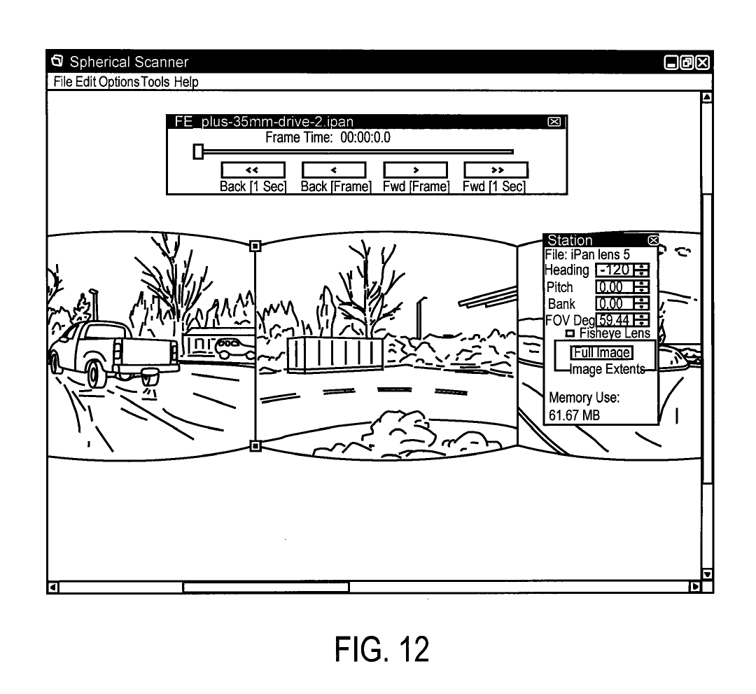

In addition to being operatively connected to the viewer module 48, the data store 48 may also be operatively connected to a calibration module 50 (use and operation of the calibration module 50 further described below with reference to FIGS. 12-17). In general, the calibration module 50 offers a user the ability to modify the set of information by which the viewer module 48 renders images. More particularly, for example, the calibration module 50 provides a set of tools by which the user can access images from the data store 46, modify settings for the images in an effort to improve or otherwise change in some way how the images should be rendered (e.g., adjusting a height of an image, adjusting a field of view of an image, adjusting a horizontal axis of the image, adjusting a vertical axis of the image).

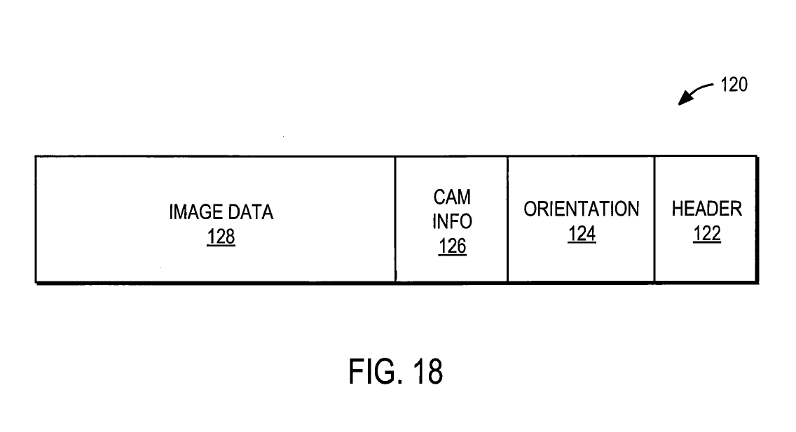

As a result of modifying settings associated with images through use of the calibration module 50, information is added to the associated streams of images. The addition of such information is captured and stored in the data store 46 according to a particular type of file format (such a file format further described below with reference to FIG. 18), which, in one or more embodiments, may differ from the type of file format used to store image data prior to image modification through use of the calibration module 50. In other words, in one more embodiments, fresh images from the separated video cameras 32, 34, 36, 38, 40, 42 are captured and stored in a first file format, whereupon those images are stored according to a second file format if and after settings associated with the images are modified by the calibration module 50. The viewer module 48 is then further capable of visually rendering images stored in the second file format according to the settings specified therein.

The various separated video cameras 32, 34, 36, 38, 40, 42 and modules 44, 46, 48, 50 of the panoramic imaging system 30 described above with reference to FIG. 2 are described as being “operatively connected.” In general, two components in the panoramic imaging system 30 may be operatively connected either via wire or wirelessly (or both). For example, the capture module 44 may wirelessly communicate captured image data to the data store 46. Moreover, in one or more embodiments, the capture module 44 and the data store 46 may communicate over a data bus (in the case, for example, the capture module 44 and the data store 46 are resident on the same machine). Further, in one or more embodiments, one or more of the viewer module 48 and the calibration module 50 may wirelessly communicate data with the data store 46. Moreover, in one or more embodiments, the viewer module 48 may be operatively connected to the capture module 44 such that the viewer module 48 can directly render images as they are captured by the capture module (instead of, for example, retrieving captured images as they are stored in the data store 46).

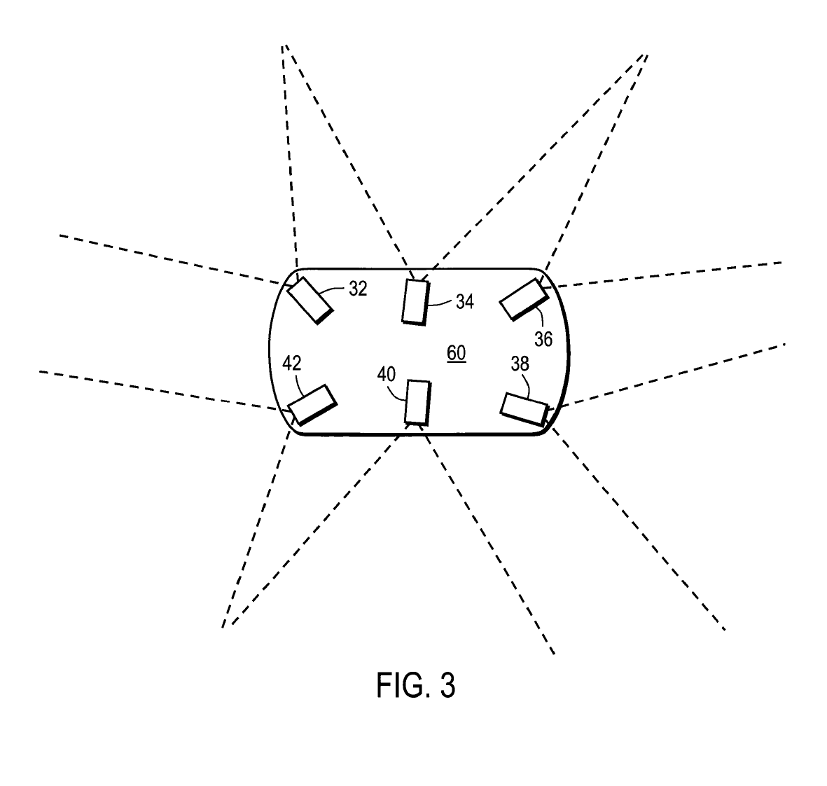

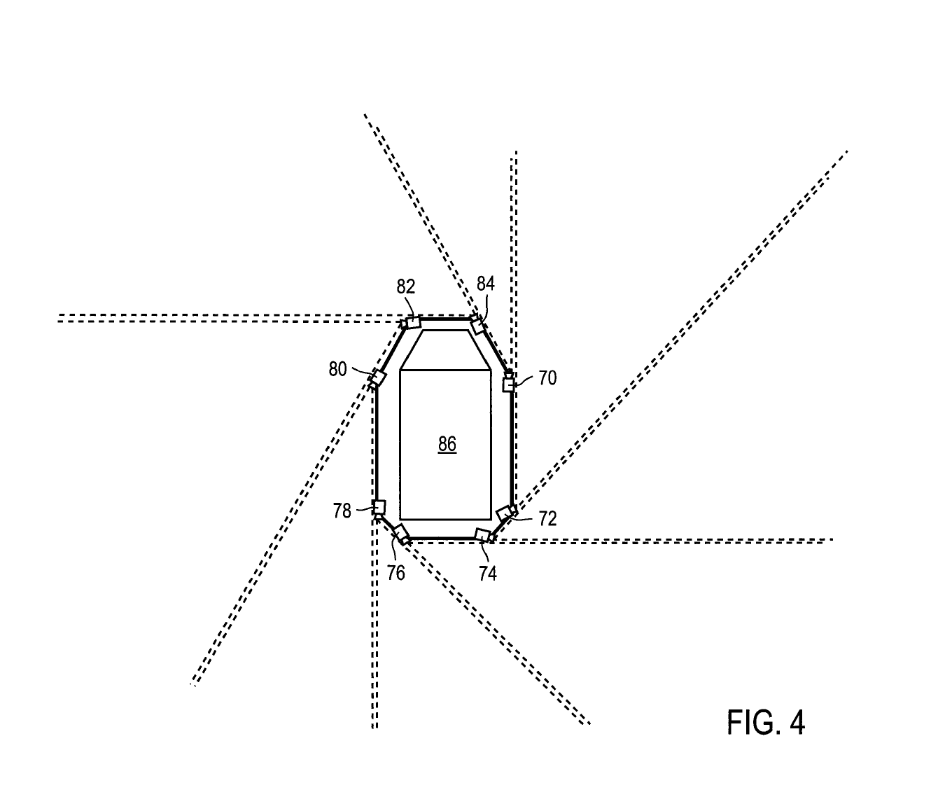

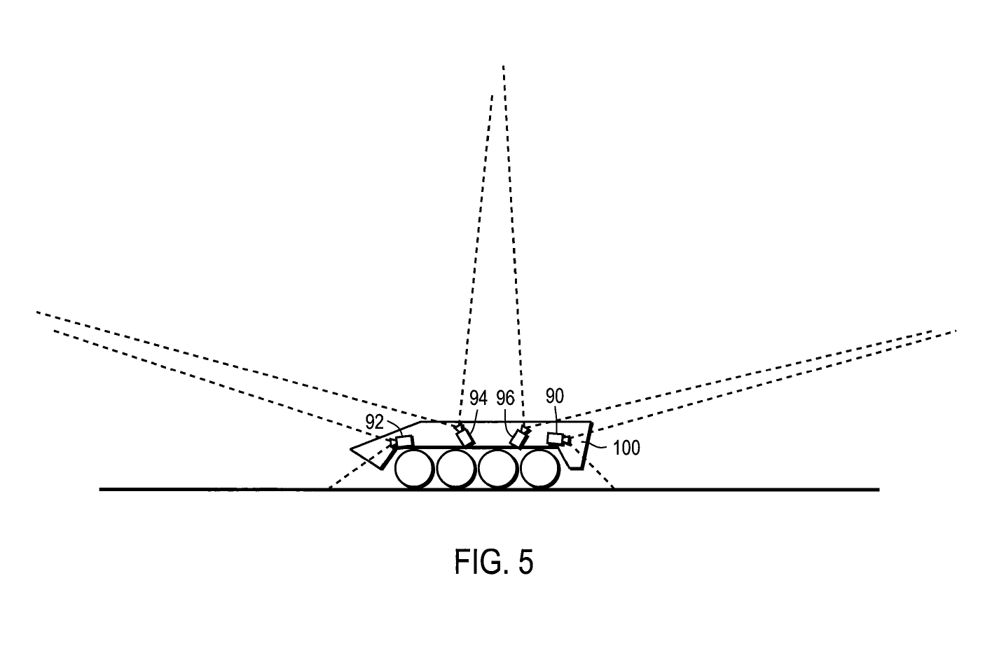

FIG. 3 shows an example of an arrangement of the separated video cameras 32, 34, 36, 38, 40, 42 around the inside of an object 60, where, here, the object is a vehicle. FIG. 4 shows another example of an arrangement of separated video cameras Here, eight separated video cameras 70, 72, 74, 76, 78, 80, 82, 84 are distributed around a vehicle 86. The arrangement shown in FIG. 4 may be particularly useful for applications in which the object has a number of distinct vertices. Further, in one or more embodiments, it may desirable to obtain scene data having a large vertical field of view (in addition to or instead of a wide horizontal field of view). Accordingly, as shown in FIG. 5, separated video cameras 90, 92, 94, 96 may be distributed around a vehicle 100 to capture images of a large vertical field of view.

As discernible from the arrangement of the separated video cameras 32, 34, 36, 38, 40, 42 shown in FIG. 3, an initial positioning of the separated video cameras 32, 34, 36, 38, 40, 42 in the vehicle 60 may not be conducive to optimal or desired panoramic imaging because the overlapping portions of the images result in a waste of pixels in the images captured by the separated video cameras 32, 34, 36, 38, 40, 42. Thus, in one or more embodiments, various camera alignment techniques may be used to adjust the separated video cameras 32, 34, 36, 38, 40, 42 prior to actual image capture.

Now referring to FIG. 6, it shows an example of a step of a camera alignment technique in accordance with an embodiment of the present invention. As shown in FIG. 6, initially, a first separated video camera 102 is secured inside a vehicle 106. The securing of the first separated video camera 102 may occur after the vehicle 106 has been positioned (e.g., turned) such that some exterior object (e.g., a light pole, a building, a tower) 108 aligns with a right edge of the first separated video camera's 102 field of view. In one embodiment, the exterior object is located sufficiently away from the video camera 102 (for example, over 100 meters).

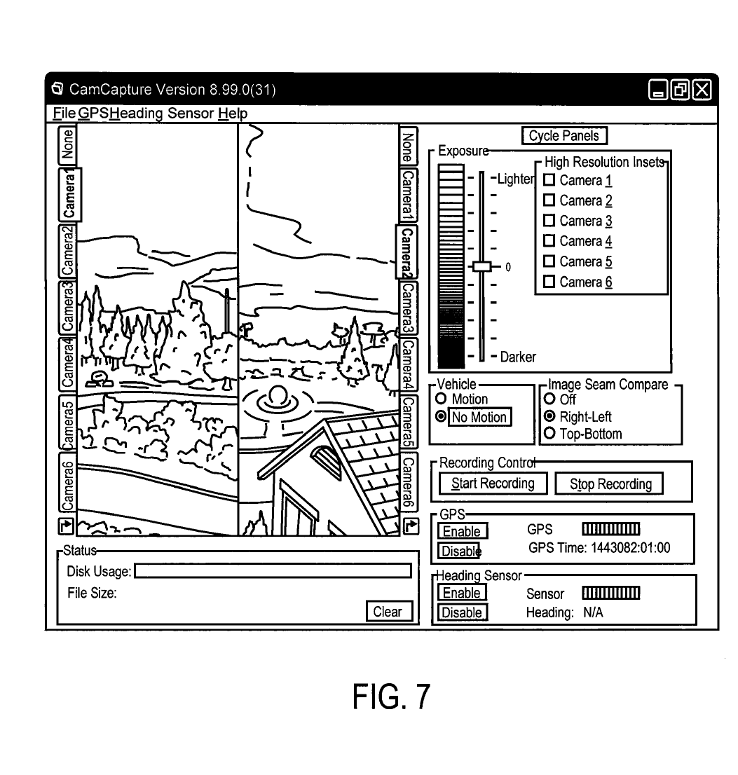

In one or more embodiments, the determination of when a right edge of the first separated video camera's 102 field of view is aligned with object 108 may be made using the capture module 44. For example, now also referring to FIG. 7, a screenshot of a use of the capture module 44 shows the field of view of each separated video camera. Thus, the capture module 44 may be used to monitor the field of view of the first separated video camera 102 while the camera 102 is adjusted in the effort to align object 108 as described above. Once aligned, the first separated video camera 102 may then be secured.

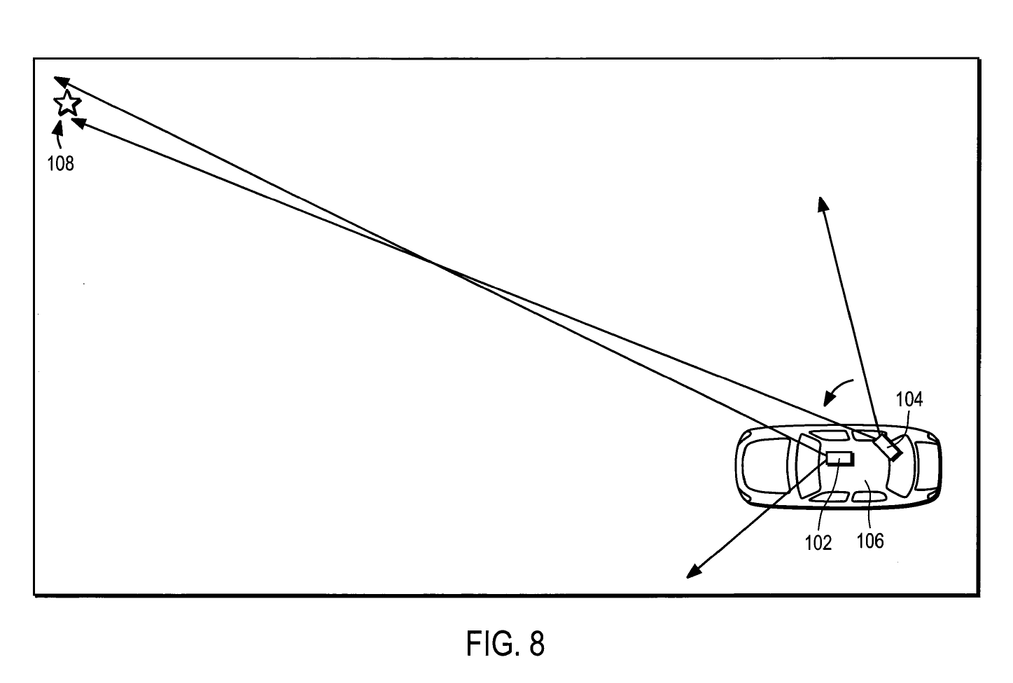

Now also referring to FIG. 8, after the first separated video camera 102 has been secured, a second separated video camera 104 may be adjusted in an effort to align object 108 with a left edge of the second separated video camera's 104 field of view. In one or more embodiments, such adjustment may actually require positioning (e.g., turning) of the vehicle 106 itself. Like with the first separated video camera 102, the capture module 44 may be used to monitor the field of view of the second separated video camera 104 as the camera 104 is adjusted for alignment with object 108. Once aligned, the second separated video camera 104 may then be secured.

Each remaining separated video camera (not shown) in the vehicle 106 is aligned similarly to how the first and second separated video camera 102, 104 were aligned as described above with reference to FIGS. 6-8. Once all the separated video cameras in the vehicle 106 are aligned and secured, subsequent image capture will result in a panoramic image capture (as opposed to a potentially non-ideal, non-optical, or otherwise undesirable panoramic image capture using separated video cameras 32, 34, 36, 38, 40, 42 that are not aligned as shown in FIG. 3). The aligned video cameras generate images with less overlapping portions; and therefore, the pixels of the images are put to a more efficient use compared to unaligned video cameras.

As described above with reference to FIGS. 6-8, separated video cameras 102,104 may be adjusted and secured. In terms of implementation, in one or more embodiments, one or more of the separated video cameras 102, 104 may be distributed within the vehicle 106 using, for example, a suction cup, a mounting bracket, screws, and/or other types of affixing devices. Adjustment of one or more of the separated video cameras 102, 104 may involve adjusting and securing a position of the cameras 102, 104 by, for example, turning a screw-based knob, physically adjusting a mounting bracket, and/or otherwise physically moving the cameras 102, 104.

Further, it may be desirable to perform an alignment of separated video cameras indoors. For example, in one or more embodiments, lasers may be used to perform camera alignment in an indoor setting.

As described above with reference to FIG. 2, images taken by separated video cameras 32, 34, 36, 38, 40, 42 (e.g., 70, 72, 74, 76, 78, 80, 82, 84 in FIG. 4; 90, 92, 94, 96 in FIG. 5; 102, 104 in FIGS. 6 and 8) are outputted by the separated video cameras 32, 34, 36, 38, 40, 42 to the capture module 44 in some native, or raw, format. For example, the raw images from the separated video cameras 32, 34, 36, 38, 40, 42 may be in a JPEG file format or a GIF file format. The capture module 44 takes the raw images and converts them into a particular file format for subsequent storage in the data store 46.

Further, in one or more embodiments, a set of the separated video cameras 32, 34, 36, 38, 40, 42 may be supplemented with one or more “high-resolution” separated video cameras. Such a camera is designated “high-resolution” if the resolution at which it captures image data is higher than at which the separated video cameras 32, 34, 36, 38, 40, 42 capture image data. As described in further detail below with reference to FIGS. 10 and 11, in one or more embodiments, one or more high-resolution cameras may be used for inserting high-resolution images in a panoramic scene captured by the separated video cameras 32, 34, 36, 38, 40, 42.

FIG. 9 shows an example of an arrangement of a file format that may be used for conversion from raw image data in accordance with an embodiment of the present invention. Particularly, FIG. 9 shows a frame 110 for an individual image captured by one of the separated video cameras 32, 34, 36, 38, 40, 42. The frame 110, at a first portion thereof, includes a header 112. The header portion 112 has identification information uniquely identifying frame 110 (e.g., in timing relation to other image frames (not shown)). In one or more embodiments, the header information 112 may also have metadata describing the data contained in the frame 110.

The image frame 110 further includes an orientation data portion 114. This portion 114 includes information relating to a heading, a pitch, and/or a bank of the image associated with frame 110. In general, in one or more embodiments, such information is set by the capture module 44.

Still referring to FIG. 9, the image frame 110 may further include a camera data portion 116. The camera data portion 116 includes information about the particular separated video camera used to capture the image associated with frame 114. For example, the camera data portion 116 may specify that the image associated therewith was taken by separated video camera 34 having a resolution of 1280×960 pixels. Those skilled in the art will note that various other types of information may be specified in the camera data portion 116 (e.g., type of camera used, shutter speed, zoom position).

The image frame 110 also includes the image data 118 itself. As described above, in one or more embodiments, the image data may be in the form of a JPEG file or a GIF file. Those skilled in the art will note that image data 118 likely constitutes the largest portion of frame 114.

As described above with reference to FIG. 2, the viewer module 48 is capable visually rendering images stored in the data store 46. Particularly, for example, the viewer module 48 may be capable of visually rendering images stored according to the file format described above with reference to FIG. 9 (and/or the file format described in further detail below with reference to FIG. 18).

FIG. 10 shows an example of a screenshot rendered by the viewer module 48 in accordance with an embodiment of the present invention. As described above, in one or more embodiments, the viewer module 48 may be used to render captured images in real-time (e.g., virtually simultaneously rendered from the data store 46 as images are deposited in the data store 46 by the capture module 44). Further, in one or more embodiments, the viewer module 48 may be used to render capture images in a non-real-time manner. For example, as shown via the control user interface in FIG. 11, a user can select a particular image frame to view. Particularly, for example, an image frame may be selected based on a timing relation to a currently displayed frame (e.g., go back 1 second, go back 1 frame, go forward 1 second, go forward 1 frame). In still another example, an image frame may be selected for display by simply choosing a time of interest (e.g., as shown in FIG. 11, via use of the frame time scroll bar).

Although not present in the screenshot shown in FIG. 10, the viewer module 48 may render a high-resolution insert image with one or more of the rendered captured images. As described above, such a high-resolution insert image has a higher resolution than that of at least one other image captured with a non-high-resolution separated video camera. Use of a video camera to capture a high-resolution image may be useful, for example, in cases where it is desirable to have a clearer view (e.g., clearer as the high-resolution image is zoomed in on) of a particular area or region in the field of view of a panoramic imaging system in accordance with one or more embodiments.

Referring again to FIG. 2, the calibration module 50 may be used to adjust how images are ultimately rendered by the viewer module 48. The calibration module 50 offers a variety of different tools by which a user can modify captured image settings. In general, the calibration module 50 may be thought of as being used to “build a scene” by desirably aligning images captured by the separated video cameras 32, 34, 36, 38, 40, 42.

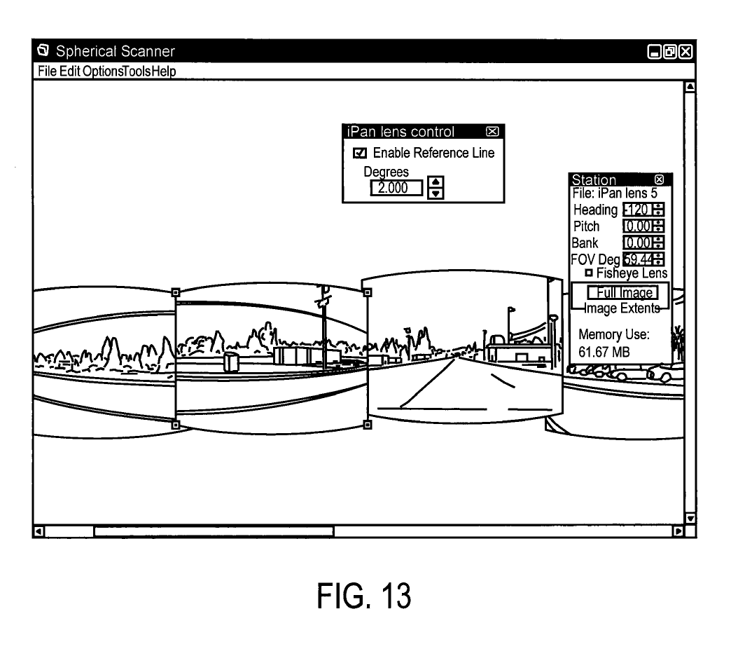

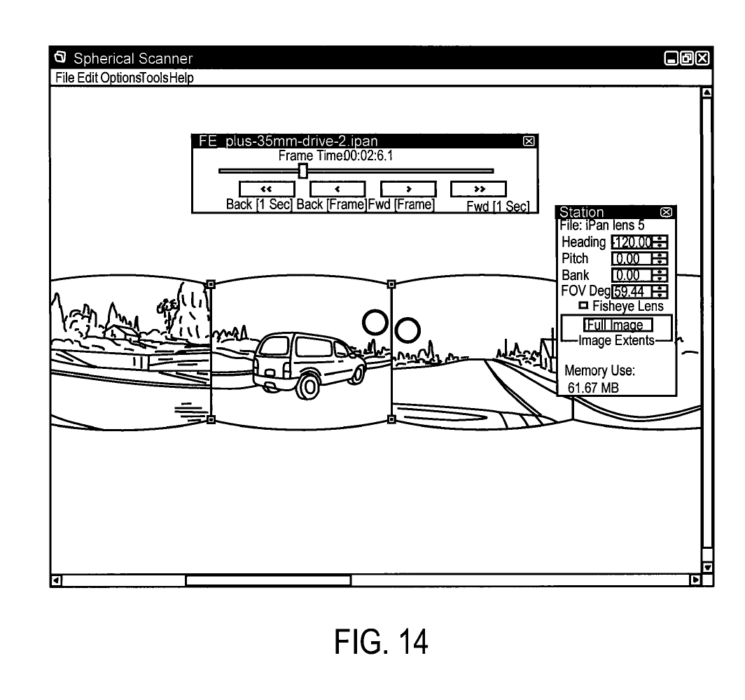

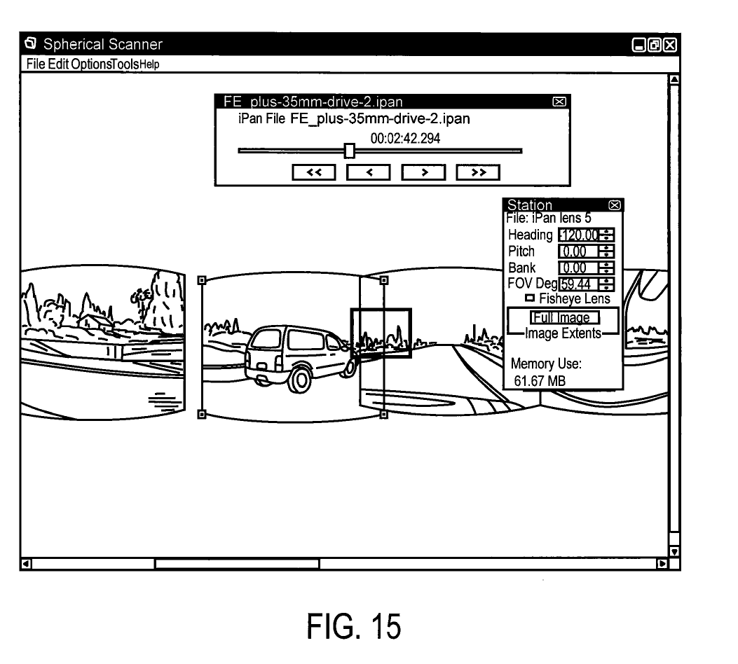

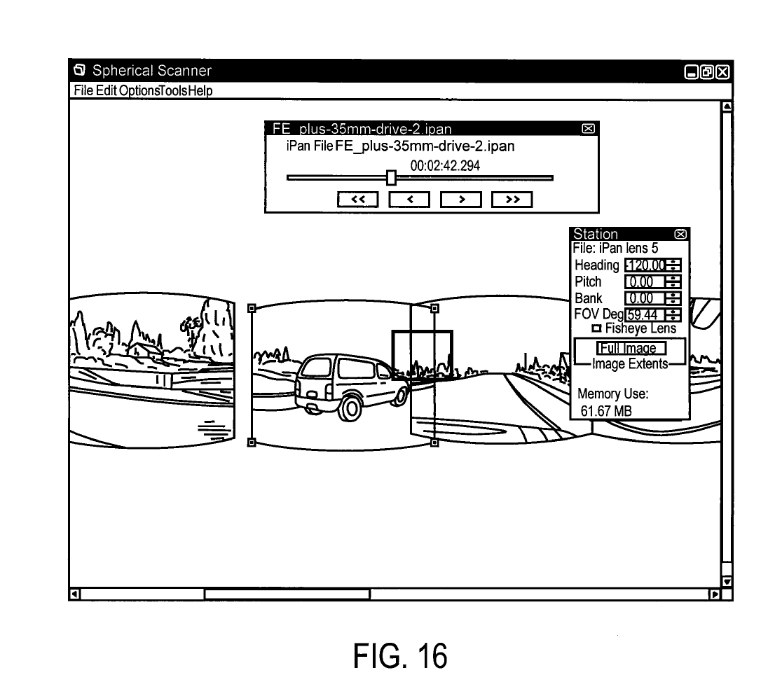

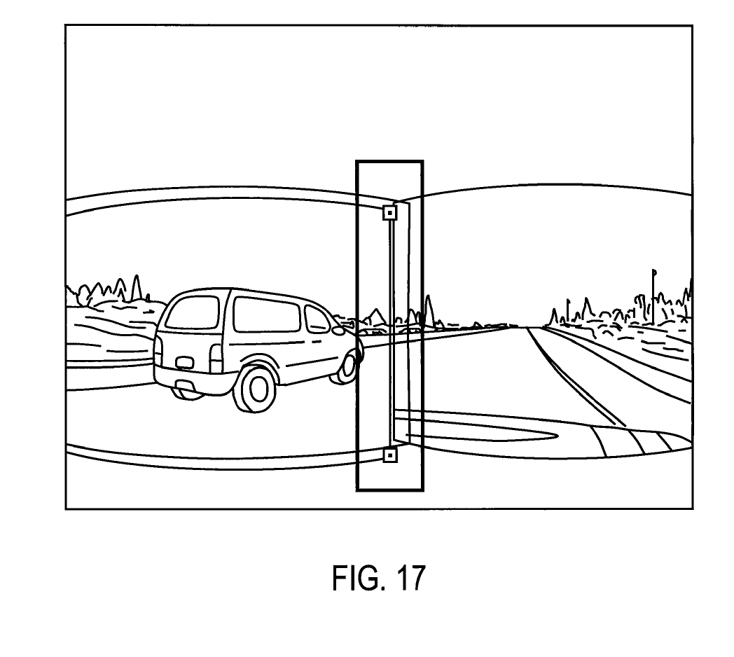

FIGS. 12-17 show examples of various screenshots of the calibration module 50, the depictions of which illustrate how captured image settings may be modified. Particularly, FIG. 12 shows a user interface upon opening images stored in a file format, such as the one described above with reference to FIG. 9. The screenshot in FIG. 13 shows correction of an image for bank and pitch. FIG. 14 shows a technique by which images captured by adjacent separated video cameras may be aligned. The screenshot in FIG. 15 also shows a technique by which images captured by adjacent separated video cameras may be aligned. FIG. 16 shows completion of a seam adjustment. The screenshot in FIG. 17 shows a technique by which borders (or “extents) may be adjusted for, for example, the purpose of aligning images.

Upon modification of captured images according to, for example, the various techniques described above with reference to FIGS. 12-17, the captured images and associated setting information are stored in the data store 46 according to a particular file format. This particular file format may represent a type of file format associated with the calibration module 50. Further, in one or more embodiments, the file format used to store captured image data upon treatment by the calibration module 50 may differ from the file format used to store captured image data upon initial capture from the separated video cameras 32, 34, 36, 38, 40, 42 (e.g., the file format described above with reference to FIG. 9).

FIG. 18 shows an example of an arrangement of a file format that may be used for handling captured image data and information modified with the calibration module 50 in accordance with an embodiment of the present invention. In other words, the file format shown in FIG. 18 may represent “aligned” captured image data.

In FIG. 18, an image frame 120, at a first portion, includes a header portion 122. The header portion 122 has identification information uniquely identifying frame 120 (e.g., in timing relation to other image frames (not shown)). In one or more embodiments, the header information 122 may also have metadata describing the data contained in the frame 120.

The image frame 120 may further include a camera data portion 124. The camera data portion 124 includes information about the particular separated video camera used to capture the image associated with frame 120. For example, the camera data portion 124 may specify that the image associated therewith was taken by separated video camera 34 having a resolution of 1280×960 pixels. Those skilled in the art will note that various other types of information may be specified in the camera data portion 124 (e.g., type of camera used, shutter speed, zoom position).

Further, in one or more embodiments, the image frame 120 may include an alignment settings portion 126. Particularly, this portion 126 may contain any information associated with camera alignment settings that were modified with the calibration module 50 described above with reference to FIGS. 2 and 12-17. Moreover, in one or more embodiments, the alignment settings portion 126 may be associated with information that was stored in the orientation info portion 114 in the image frame 110 described above with reference to FIG. 9.

Still referring to FIG. 18, the image frame 120 also includes the image data 128 itself. As described above, in one or more embodiments, the image data may be in the form of a JPEG file or a GIF file. Those skilled in the art will note that image data 128 likely constitutes the largest portion of frame 120.

The various embodiments of a panoramic imaging system described above with reference to FIGS. 2-18 may be used in various different types of applications. For example, separated video cameras in a panoramic imaging system according to one or more embodiments may be used for surveillance around a vehicle. Further, for example, in one or more embodiments, separated video cameras in a panoramic imaging system may be used for surveillance around a building structure (e.g., an office building). Moreover, in one or more embodiments, separated video cameras in a panoramic imaging system may be used to perform surveillance, or otherwise monitor, a certain area, region, landmark, or landscape (e.g., a particular portion of a road, a home, a store, a residential area, a school, a military installation, an enemy foothold, a national security interest, a utility plant, a nuclear reactor).

While the invention has been described with respect to a limited number of embodiments, those skilled in the art, having benefit of the above description, will appreciate that other embodiments may be devised which do not depart from the scope of the present invention as described herein. Accordingly, the scope of the present invention should be limited only by the appended claims.

What is claimed is:

1. A panoramic imaging system, comprising:
a plurality of separated video cameras capable of being distributed around an object, wherein a series of images captured by at least one of the separated video cameras is stored in a first file format;
a viewer module capable of rendering the series of images using the first file format; and
a calibration module capable of modifying information associated with at least one of the series of images, wherein the modification results in the series of images being stored in a second file format, and
wherein the viewer module is capable of rendering the series of images using the second file format.

2. The panoramic imaging system of claim 1, wherein the object is one of a vehicle and a building structure.

3. The panoramic imaging system of claim 1, wherein each of the images in the series of images is captured in one of a JPEG format and a GIF format.

4. The panoramic imaging system of claim 1, wherein the viewer module is capable of rendering the series of images as they are captured.

5. The panoramic imaging system of claim 1, wherein at least one image in the series of images is individually selectable using the first file format.

6. The panoramic imaging system of claim 1, wherein at least one of the plurality of separated video cameras is capable of capturing a series of images at a resolution higher than a resolution at which another of the plurality of separated video cameras captures a series of images.

7. The panoramic imaging system of claim 6, wherein the higher resolution series of images is capable of being integrated into the first file format.

8. The panoramic imaging system of claim 1, further comprising:
a capture module capable of converting a raw image format of the series of images into the first file format.

9. The panoramic imaging system of claim 1, further comprising:
a data store capable of storing images in the first file format and the second file format, wherein the data store is operatively connected to the viewer module and the calibration module.

10. The panoramic imaging system of claim 1, wherein at least one of the plurality of separated video cameras is disposed on an exterior of the object.

11. The panoramic imaging system of claim 1, wherein at least one of the plurality of separated video cameras is disposed on an interior of the object.

12. The panoramic imaging system of claim 1, wherein at least one of the plurality of separated video cameras, the viewer module, and the calibration module is capable of communicating data wirelessly.

13. A panoramic imaging method, comprising:
capturing images with separated video cameras distributed around an object;
storing at least one of the captured images in a first file format, wherein the at least one captured image is renderable according to a first set of information; and
aligning the at least one captured image, wherein the aligning results in generation of a second set of information capable of being stored with the at least one captured image in a second file format,
wherein the at least one captured image is renderable according to the second set of information.
